(19) United States
(12) Patent Application Publication
(10) Pub. No.: US 2026/0280718 A1
(43) Pub. Date: Sep. 17, 2026

(54) OPTICAL RECEIVING APPARATUS AND SIGNAL DETECTION METHOD

(71) Applicant: NTT, Inc., Tokyo (JP)

(72) Inventors: Ryo KOMA, Musashino-shi (JP); Junichi KANI, Musashino-shi (JP); Kazutaka HARA, Musashino-shi (JP); Ryo IGARASHI, Musashino-shi (JP)

(73) Assignee: NTT, Inc., Tokyo (JP)

(21) Appl. No.: 19/479,822

(22) PCT Filed: May 22, 2023
(86) PCT No.: PCT/JP2023/018921

§ 371 Date: Oct. 29, 2025

(51) Int. Cl. H04B 10/61; H04B 10/50

(52) U.S. Cl. CPC H04B 10/6164; H04B 10/505; H04B 10/6165

(57) ABSTRACT

The optical reception device includes: a vector sum estimation unit that estimates a vector sum of symbols in a differentially detected training signal; and a detection unit that detects a period of receipt of at least the training signal on the basis of at least either a comparison result of comparison between an absolute value of the vector sum of symbols in the differentially detected training signal and an absolute value threshold, or a comparison result of comparison between a variation of a phase of the vector sum of symbols in the differentially detected training signal and a predetermined width. The optical reception device may further include: an offset amount estimation unit that estimates a frequency offset amount on the basis of the phase of the vector sum of symbols in the differentially detected training signal when the period of receipt of the differentially detected training signal is detected; and a compensation amount determination unit that determines a compensation amount of a frequency offset on the basis of the frequency offset amount and records the compensation amount in a storage unit.

### TECHNICAL FIELD

The present invention relates to an optical reception apparatus and a signal detection method.

### BACKGROUND ART

There is an optical reception device for an optical transmission system using a digital coherent receiving system. FIG. 9 is a diagram showing a configuration example of the optical reception device. The optical reception device includes a reception unit, an analogue-to-digital conversion unit (AD conversion unit), and a reception processing unit (digital signal processing unit). The reception processing unit includes a clock recovery unit, a polarized wave dispersion compensation unit, a wavelength dispersion compensation unit, an offset compensation unit, and a demodulation unit.

The reception unit is a polarized wave and phase diversity receiver. An electric field component of signal light is input to the reception unit from an optical transmission device (not shown in FIG. 9). An electric field component of locally generated light (local light) is input to the reception unit from a locally generated light source. The reception unit generates signal light based on a difference (beat component) between a frequency of input signal light and a frequency of input locally generated light by causing the signal light and the locally generated light to interfere with each other. The reception unit converts the generated signal light into electrical signal.

The AD conversion unit converts the resultant electrical signal (analog signal) into a received signal (digital signal). The reception processing unit compensates for deterioration of the received signal. The deterioration of the received signal is, for example, a deterioration due to phase rotation depending on the difference between the frequency of the signal light and the frequency of the locally generated light. The reception processing unit performs demodulation processing on the received signal whose deterioration is compensated.

FIG. 10 is a diagram showing an example of the difference (frequency offset amount) between the frequency of the signal light and the frequency of the locally generated light. Depending on the frequency offset amount “Δf,” a phase rotation of a symbol occurs on a complex plane (on an IQ plane). The offset compensation unit compensates for deterioration in characteristics of the received signal affected as described above. Note that the phase rotation of the symbol occurs on the complex plane due to noise in an optical transmission line.

FIG. 11 is a diagram showing an example of phase compensation. For example, when signal light based on QPSK (Quadrature Phase Shift Keying) modulation is received, the phases of four symbols based on the QPSK modulation rotate on the complex plane as shown on the left side in FIG. 11. The frequency offset compensation unit estimates the frequency offset amount. The offset compensation unit, based on the estimated amount of the frequency offset amount, compensates for the rotation of the phases of the four symbols as shown on the right side in FIG. 11. Thus, deterioration of signal characteristics due to frequency offset is compensated.

In the frequency offset compensation method, the frequency offset amount that can be estimated in the M-PSK (Phase Shift Keying) modulation method is “±B/2” (see NPDs 1, 2 and 3). Here, “M” represents a multi-valued degree. The term “B” represents the baud rate (symbol rate) of the signal light.

The frequency offset compensation methods include a blind method and a training method. In the blind method, a random received signal is used to compensate for the frequency offset. In the training method, a frequency offset is compensated using a training signal (training symbol) inserted between main signals.

As one of the blind methods, there is a PADE (Pre-decision-based Angle Differential Estimator) method (see NPD 1). In the PADE method, a phase value of a symbol is temporarily determined on the basis of an estimated amount of a modulation component of locally generated light before one symbol time and an estimated amount of a frequency offset amount. On the basis of the temporarily determined phase values, the phase term of the symbol (nπ/4 (n=1, 2, 3, 4) in QPSK) is removed. Thus, an estimated range up to the frequency offset amount “±B/2” is realized.

However, since feedback control is used to estimate the modulation component of locally generated light, time is required for the estimation. Therefore, it is difficult to use the PADE method for uplink communication of a PON (Passive Optical Network) that may receive a burst signal.

Also, as a method of compensating for the frequency offset using known training signals, there is a method of eliminating modulation components based on the result of the multiplication of the received training signal and the complex conjugate components of the training signal (see NPD 2). In this method, the frequency offset amount is estimated in a feed-forward method that provides high responsiveness. However, very high accuracy is required to detect the period of receipt (receiving timing) of a training signal.

As a frequency offset compensation method that is less susceptible to a training signal detection error, there is a method using a training signal that is encoded so that the constellation of symbols obtained by differential detection is asymmetric (see NPD 3).

FIG. 12 is a diagram showing a configuration example of the offset compensation unit. The offset compensation unit (detection circuit) shown in FIG. 12 executes the received signal processing described in NPD 3. A position detection unit detects a period of receipt (a position of a training symbol in a signal sequence) of a training symbol “aᵣ” that is a symbol in a training signal. A differential detection unit performs differential detection processing on the training symbol “aᵣ” for which the period of receipt has been detected.

FIG. 13 is a diagram showing an example of vector sum of differentially detected signal sequences. Here, the modulation method is, for example, a 4-QAM (Quadrature Amplitude Modulation) method. If the frequency offset amount “Δf” is 0, the constellation of symbols is as shown on the left side in FIG. 13. If the frequency offset amount “Δf” is “+B/8,” the constellation of symbols is as shown on the left side in FIG. 13. The training symbols “aᵣ” in the received signal are differentially encoded by an optical transmission device such that the phases of those symbols are “nπ/2 (n=1, 2, 3).” The differential detection unit generates a training symbol “Aᵣ” in the differentially detected received signal. The training symbol “Aᵣ” in the differentially detected received signal is represented by the equation (1).

$$\begin{matrix}[ Math . 1 ] & \\ {A}_{r} ( t ) = {a}_{r} ( t ) \cdot {a}_{r} ( t - T ) * ≅ exp \{ j ( \frac{n π}{2} + 2 π Δ fT + {θ}_{n}^{′} ( t ) ) \} & ( 1 )\end{matrix}$$

The term “T” represents the frequency of the symbol. The first term “nπ/2” of the phase component of the equation (1) is a modulation component. The second term “2πΔfT” of the phase component in the equation (1) is a component of a frequency offset due to the frequency offset amount “Δf” which is a difference between the frequency of locally generated light “LO” and the frequency of signal light. The third term of the phase component of the equation (1) “θ′ₙ (t)” is noise (phase noise).

The estimated amount of frequency offset “Δfₑₛₜ” is represented by the equation (2).

$$\begin{matrix}[ Math . 2 ] & \\ Δ {f}_{est} = \frac{arg ( {\sum }_{i = 1}^{N} {A}_{r} ) - π}{2 π T} & ( 2 )\end{matrix}$$

For “N” symbols corresponding to the length of the training symbol (average number), the vector sum of the training symbol “Δr” in the received signal is estimated, so that the modulation component of “n=1” and the modulation component of “n=3” cancel each other.

FIG. 14 is a flowchart showing an example of an operation of the offset compensation unit. The position detection unit detects the timing of the training symbol “aᵣ” in the received signal. The differential detection unit generates a differentially detected received signal “Aᵣ.” A vector sum estimation unit estimates a vector sum “Σ^{N}ᵢ₌₁Aᵣ” of the differentially detected received signal “Aᵣ.” The compensation amount determination unit estimates a phase of the vector sum “Arg(Σ^{N}ᵢ₌₁Aᵣ).” Based on the phase of the vector sum “Arg(Σ^{N}ᵢ₌₁Aᵣ),” the compensation amount determination unit determines the frequency offset amount “Δfₑₛₜ.” The compensation amount determination unit determines the frequency offset compensation amount on the basis of the frequency offset amount “Δfₑₛₜ.”

Thus, even if the accuracy of detecting the period of receipt of the training signal is not high, the estimation error of the frequency offset amount can be reduced by the effect of averaging by the vector sum of the received signal “Aᵣ.” However, as a circuit for detecting the timing of the training signal, the offset compensation unit must be provided with the position detection unit. The circuit for detecting timing is, for example, a circuit for detecting timing based on delay correlation analysis using signal auto-correlation.

FIG. 15 is a diagram showing an example of a signal sequence and a correlation value. A circuit for detecting timing based on delay correlation analysis uses a repetition pattern of a predetermined length as a training signal (training symbol “TS”). The circuit for detecting timing estimates the sum (correlation value “Corr”) of complex multiplied components of an undelayed symbol and a symbol delayed by the length of the repeated pattern. The correlation value “Corr” is expressed as in the equation (3).

$$\begin{matrix}[ Math . 3 ] & \\ Corr = {\sum }_{i = 1}^{N} S ( i ) \cdot {S ( i + NT )}^{*} & ( 3 )\end{matrix}$$

Two training signals are arranged immediately before the main signal sequence, so that two training signals are arranged in the signal sequence at regular intervals for each main signal sequence. The correlation value is the maximum at the beginning of the training signal.

FIG. 16 is a diagram showing a configuration example of the position detection unit. The position detection unit includes a delay circuit, a complex multiplier circuit, and a detection circuit. The delay circuit outputs a delay signal of the received signal to the complex multiplier circuit. The complex multiplier circuit outputs the sum (correlation value) of complex multiplied components of the delay signal of the received signal and the received signal, to the detection circuit. The detection circuit compares the correlation value to a threshold.

### CITATION LIST

### Non Patent Documents

NPD 1: Lei Li, Zhenning Tao, Shoichiro Oda, Takeshi Hoshida, Jens C. Rasmussen, “Wide-range, Accurate and Simple Digital Frequency Offset Compensator for Optical Coherent Receivers”, OFC/NFOEC 2008
NPD 2: Xian Zhou, Xue Chen, Keping Long, “Wide-Range Frequency Off set Estimation Algorithm for Optical Coherent Systems Using Training Sequence”, IEEE PHOTONICS TECHNOLOGY LETTERS, VOL. 24, NO. 1, Jan. 1, 2012
NPD 3: Ryo Koma, “Wide Range Carrier Frequency Offset Estimation Method using Training Symbols with Asymmetric Constellations for Burst-Mode Coherent Reception”, OFC 2018

### SUMMARY OF INVENTION

### Technical Problem

However, since the delay circuit, the complex multiplier circuit, the buffer and the like are implemented in parallel in accordance with the training symbol length, the circuit scale of the position detection unit increases. For power saving and economization, timing of the training signal must be detected without increasing the scale of the functional unit to compensate for the frequency offset. However, there is a problem that timing of the training signal cannot be detected unless the scale of the functional unit for compensating for the frequency offset is increased.

In view of the above circumstances, the present invention has an object to provide an optical reception device and a signal detection method that can detect timing of a training signal without increasing the scale of a functional unit for compensating for a frequency offset.

### Solution to Problem

One aspect of the present invention is an optical reception device that includes: a vector sum estimation unit that estimates a vector sum of symbols in a differentially detected training signal: and a detection unit that detects a period of receipt of at least the training signal on the basis of at least either a comparison result of comparison between an absolute value of the vector sum of symbols in the differentially detected training signal and an absolute value threshold, or a comparison result of comparison between a variation of a phase of the vector sum of symbols in the differentially detected training signal and a predetermined width.

One aspect of the present invention is a signal detection method executed by the optical reception device described above, the signal detection method including the steps of: estimating a vector sum of symbols in a differentially detected training signal: and detecting a period of receipt of at least the training signal on the basis of at least either a comparison result of comparison between an absolute value of the vector sum of symbols in the differentially detected training signal and an absolute value threshold, or a comparison result of comparison between a variation of a phase of the vector sum of symbols in the differentially detected training signal and a predetermined width.

### Advantageous Effects of Invention

According to the present invention, it is possible to detect the period of receipt of the training signal without increasing the scale of the functional unit for compensating for the frequency offset.

### BRIEF DESCRIPTION OF DRAWINGS

FIG. 1 A diagram showing a configuration example of an optical transmission system according to a first embodiment.

FIG. 2 A diagram showing a configuration example of an estimation compensation unit according to the first embodiment.

FIG. 3 A flowchart showing an operation example of the estimation compensation unit according to the first embodiment.

FIG. 4 A diagram showing an example of a signal sequence according to a second embodiment.

FIG. 5 A diagram showing examples of an absolute value and a phase of a vector sum of a differentially detected QPSK signal sequence according to the second embodiment.

FIG. 6 A diagram showing an example of detection of a period of receipt of a training signal according to the second embodiment.

FIG. 7 A diagram showing an example of detection of a period of receipt of a training signal according to a modification of the second embodiment.

FIG. 8 A diagram showing an example of a hardware configuration of a digital signal processing device according to an embodiment.

FIG. 9 A diagram illustrating a configuration example of an optical reception device.

FIG. 10 A diagram showing an example of a difference between a frequency of signal light and a frequency of locally generated light.

FIG. 11 A diagram showing an example of compensation of a phase.

FIG. 12 A diagram showing a configuration example of an offset compensation unit.

FIG. 13 A diagram showing an example of a vector sum of differentially detected signal sequences.

FIG. 14 A flowchart showing an operation example of the offset compensation unit.

FIG. 15 A diagram showing examples of a signal sequence and a correlation value.

FIG. 16 A diagram showing a configuration example of a position detection unit.

### DESCRIPTION OF EMBODIMENTS

Embodiments of the present invention will be described in detail with reference to the drawings.

### First Embodiment

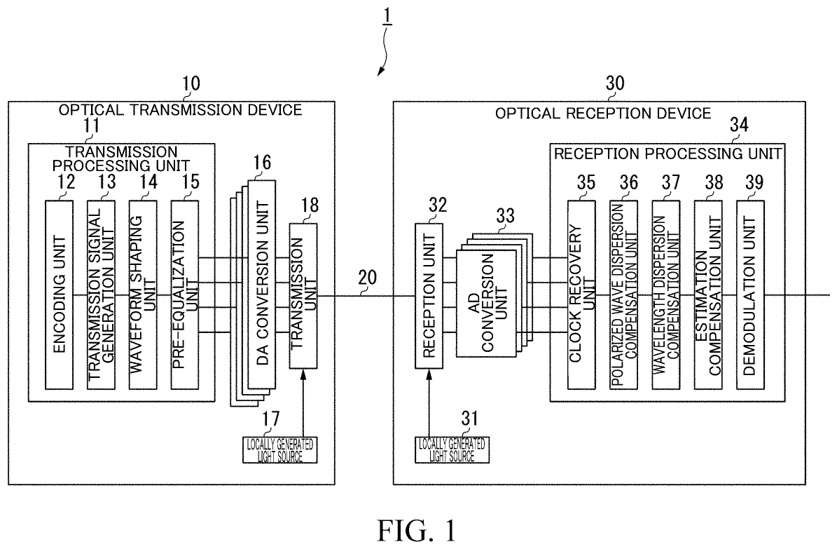

FIG. 1 is a diagram showing a configuration example of an optical transmission system 1 according to a first embodiment. The optical transmission system 1 is a system configured to transmit signal light. The optical transmission system 1 includes an optical transmission device 10, an optical transmission line 20, and an optical reception device 30.

The optical transmission device 10 includes a transmission processing unit 11. The transmission processing unit 11 includes an encoding unit 12, a transmission signal generation unit 13, a waveform shaping unit 14, and a pre-equalization unit 15. The optical transmission device 10 includes a plurality of DA conversion units 16, a locally generated light source 17, and a transmission unit 18. In FIG. 1, the optical transmission device 10 includes four DA conversion units 16.

The optical reception device 30 includes a locally generated light source 31, a reception unit 32, four AD conversion units 33, and a reception processing unit 34. In FIG. 1, the optical reception device 30 includes the four AD conversion units 33. The reception processing unit 34 includes a clock recovery unit 35, a polarized wave dispersion compensation unit 36, a wavelength dispersion compensation unit 37, an estimation compensation unit 38, and a demodulation unit 39.

First, the optical transmission device 10 will be described. The encoding unit 12 may execute, for example, forward error correction (FRC) encoding on a data sequence (bit string) to be transmitted. The encoding unit 12 outputs the bit string on which encoding was executed, to the transmission signal generation unit 13.

The transmission signal generation unit 13 maps the data sequence to be transmitted to symbols. The transmission signal generation unit 13 generates a training signal so that the phase of the vector sum of differentially detected symbols becomes an arbitrary value. Here, the transmission signal generation unit 13 generates a training signal by differential encoding so that the differentially detected symbols have an asymmetric distribution on a complex plane.

The waveform shaping unit 14 executes Nyquist filtering and the like on a symbol sequence generated by the mapping. As a result, a bandwidth of a transmission signal is limited. The pre-equalization unit 15 compensates for distortion of the waveform of the transmission signal of which the bandwidth is limited. The pre-equalization unit 15 outputs the transmission signal whose waveform distortion is compensated, to the DA conversion units 16.

The DA conversion units 16 are digital analog converter (DAC). The first DA conversion unit 16 corresponds to an I (In-phase) component of an X-polarized wave. The second DA conversion unit 16 corresponds to a Q (Quadrature-phase) component of the X-polarized wave. The third DA conversion unit 16 corresponds to the I component of a Y-polarized wave. The fourth DA conversion unit 16 corresponds to the Q component of the Y-polarized wave. The DA conversion units 16 convert a transmission signal (digital signals) output from the pre-equalization unit 15 into an analog signal. The DA conversion unit 16 outputs a transmission signal (analog signal) to the transmission unit 18.

The locally generated light source 17 is, for example, a laser diode. The locally generated light source 17 outputs locally generated light (local light) of a predetermined frequency to the transmission unit 18.

The transmission unit 18 modulates the locally generated light output from the locally generated light source 17 by using the transmission signals output from the four DA conversion units 16. Specifically, the transmission unit 18 generates X-polarized signal light by modulating locally generated light by using an analogue signal of the I component of the X-polarized wave and an analogue signal of the Q component of the X-polarized wave. The transmission unit 18 generates Y-polarized signal light by modulating locally generated light by using the analogue signal of the I component of the Y-polarized wave and the analogue signal of the Q component of the Y-polarized wave.

The transmission unit 18 generates polarization-multiplexed signal light by multiplexing the X-polarized signal light and the Y-polarized signal light. The transmission unit 18 outputs the polarization-multiplexed signal light to the optical transmission line 20. The optical transmission line 20 transmits the polarization-multiplexed signal light to the optical reception device 30.

Next, the optical reception device 30 will be described. The optical reception device 30 detects a period of receipt of a training signal (training symbol) on the basis of the vector sum of a constellation of the differentially detected symbols. The optical reception device 30 compensates for a frequency offset in the received signal on the basis of the period of receipt of the training signal.

The locally generated light source 31 is, for example, a laser diode. The locally generated light source 31 outputs locally generated light (local light) of a predetermined frequency to the reception unit 32.

The reception unit 32 is a polarized wave and phase diversity receiver. The reception unit 32 receives an electric field component “E_{S}” of the signal light transmitted from the optical transmission device 10 from the optical transmission line 20 by digital coherent reception. Specifically, the reception unit 32 separates the received signal light into X-polarized signal light and Y-polarized signal light. The reception unit 32 causes the X-polarized signal light to interfere with the locally generated light of the locally generated light source 31. The reception unit 32 causes the Y-polarized signal light to interfere with the locally generated light of the locally generated light source 31. As a result, the reception unit 32 generates the signal light based on the difference (beat component) between the frequency of the electric field component “E_{S}” of the input signal light and the frequency of an electric field component “E_{LO}” of the locally generated light.

The reception unit 32 detects the I component and the Q component of the X-polarized wave and the I component and the Q component of the Y-polarized wave by using signal light based on the beat component. The reception unit 32 executes photoelectric conversion on four signal light beams corresponding to the I component of the X-polarized wave, the Q component of the X-polarized wave, the I component of the Y-polarized wave, and the Q component of the Y-polarized wave. As a result, the reception unit 32 generates four electrical signals (analogue signals). The reception unit 32 converts the polarization-multiplexed signal light into four electrical signals while maintaining the phase and amplitude of the signal light. The reception unit 32 outputs the four electrical signals to the four AD conversion units 33.

The AD conversion unit 33 is an analog digital converter (ADC). The four AD conversion units 33 correspond to the I component and Q component of the X-polarized wave and the I component and Q component of the Y-polarized wave, respectively. The AD conversion units 33 convert four received signals (analog signals) into four received signals (digital signals).

The clock recovery unit 35 is, for example, a sampling frequency compensation circuit. The clock recovery unit 35 compensates for a difference in reference clock between the optical transmission device 10 and the optical reception device 30. The difference in reference clock is, for example, a difference in sampling frequency generated by a difference between an oscillation frequency of a crystal oscillator provided in the optical transmission device 10 and an oscillation frequency of a crystal oscillator provided in the optical reception device 30. The clock recovery unit 35 compensates for a difference in reference clock between the four received signals (digital signals) output from the four AD conversion units 33. The clock recovery unit 35 combines the four received signals (digital signals) whose difference in the reference clock is compensated.

The polarized wave dispersion compensation unit 36 compensates the received signal (digital signal) coupled by the clock recovery unit 35 for polarized wave dispersion generated in the transmitted signal light. The wavelength dispersion compensation unit 37 compensates the received signal subjected to the polarized wave dispersion compensation by the polarized wave dispersion compensation unit 36 for wavelength dispersion generated in the transmitted signal light.

The estimation compensation unit 38 estimates a frequency offset amount of a training symbol in the received signal on the basis of the training signal (training symbol sequence) in the received signal whose wavelength dispersion is compensated by the wavelength dispersion compensation unit 37. The estimation compensation unit 38 compensates for the frequency offset amount of the training symbol in the received signal (difference between the frequency of the signal light and the frequency of the locally generated light) on the basis of the estimated frequency offset amount.

Here, the estimation compensation unit 38 rotates a phase of each training symbol in the received signal in a direction opposite to a rotation direction obtained due to the frequency offset, on the complex plane, by the estimated frequency offset amount. The estimation compensation unit 38 may further execute predetermined phase compensation (e.g., phase noise compensation) on the received signal whose phase rotation by the frequency offset is compensated. Thus, the constellation of symbols in the data sequence of the transmitted main signal is reproduced in the data sequence of the main signal included in the payload of the received signal.

The demodulation unit 39 demodulates the transmitted bit string on the basis of the constellation of symbols in the data sequence of the reproduced main signal.

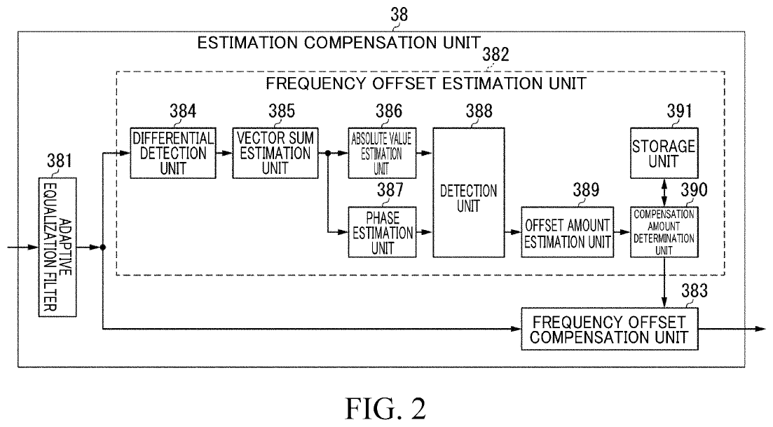

FIG. 2 is a diagram showing a configuration example of the estimation compensation unit 38 in the first embodiment. The estimation compensation unit 38 includes an adaptive equalization filter 381, a frequency offset estimation unit 382, and a frequency offset compensation unit 383. The frequency offset estimation unit 382 includes a differential detection unit 384, a vector sum estimation unit 385, an absolute value estimation unit 386, a phase estimation unit 387, a detection unit 388, an offset amount estimation unit 389, a compensation amount determination unit 390, and a storage unit 391.

The adaptive equalization filter 381 compensates for the distortion generated in the waveform of the signal light in the optical transmission line 20. That is, in the form of adaptive equalization processing, the adaptive equalization filter 381 corrects a code error caused in the signal light by inter-code interference (inter-symbol interference) in the optical transmission line 20.

The adaptive equalization filter 381 outputs a received signal whose code error has been corrected, to the differential detection unit 384 as a signal for estimating the frequency offset amount. The received signal includes a training symbol “aᵣ” that is a symbol in the training signal. Training symbols are inserted into the received signal at an arbitrary interval. The adaptive equalization filter 381 outputs the received signal whose code error has been corrected, to the frequency offset compensation unit 383 as a signal for processing the main signal.

The differential detection unit 384 executes differential detection processing on the symbol (training symbol) “aᵣ” in the received training signal. The differential detection unit 384 generates a symbol “Aᵣ” (differentially processed received signal) in the differentially detected training signal by differential detection processing.

The vector sum estimation unit 385 estimates a vector sum “Σ^{N}ᵢ₌₁Aᵣ” of symbols in the differentially detected training signal. Here, the phase of the vector sum of symbols “Σ^{N}ᵢ₌₁Aᵣ” is arbitrary.

The absolute value estimation unit 386 estimates an absolute value “Abs(“Σ^{N}ᵢ₌₁Aᵣ”)” of the vector sum of symbols in the differentially detected training signal. The phase estimation unit 387 estimates the phase “Arg(Σ^{N}ᵢ₌₁Aᵣ)” of the vector sum of symbols in the differentially detected training signal.

The detection unit 388 compares the absolute value “Abs(Σ^{N}ᵢ₌₁Aᵣ)” of the vector sum and a threshold of the absolute value (hereinafter referred to as “absolute value threshold”). The absolute value threshold is previously determined based on, for example, results of experiments, or the like. When the absolute value of the vector sum is equal to or greater than the absolute value threshold, the detection unit 388 determines that the period is the period of receipt (receiving period) of a symbol in the training signal. When the absolute value of the vector sum is less than the absolute value threshold, the detection unit 388 determines that the period is the period of receipt of a symbol in the main signal (receiving period of the main signal).

The detection unit 388 may compare the variation of the phase “Arg(Σ^{N}ᵢ₌₁Aᵣ)” of the vector sum with a predetermined width of the phase (variation width threshold). The predetermined width is previously determined based on, for example, results of experiments or the like. When the variation of the phase of the vector sum is equal to or greater than the predetermined width, the detection unit 388 may determine that the period is the period of receipt of a symbol in the training signal. When the variation of the phase of the vector sum is less than the predetermined width, the detection unit 388 may determine that the period is the period of receipt of the main signal.

When the absolute value of the vector sum is equal to or greater than the absolute value threshold and the variation of the phase of the vector sum is equal to or greater than the predetermined width, the detection unit 388 may determine that the period is the period of receipt of a symbol in the training signal. When the absolute value of the vector sum is less than the absolute value threshold or the variation of the phase of the vector sum is less than the predetermined width, the detection unit 388 may determine that the period is the period of receipt of the main signal.

It should be noted that the estimation compensation unit 38 may execute predetermined signal processing in cooperation with the function of an external signal processing device (not shown) by the detection unit 388 outputting the detection result to the signal processing device.

When it is determined that the period is the period of receipt of a symbol in the training signal (period of receipt of the training signal), the offset amount estimation unit 389 estimates a frequency offset amount “Δfₑₛₜ” on the basis of the phase “Arg(Σ^{N}ᵢ₌₁Aᵣ)” of the vector sum of symbols in the differentially detected training signal, as shown in the equation (2).

When it is determined that the period is the period of receipt of a symbol in the training signal (not the period of receipt of the main signal), the compensation amount determination unit 390 determines a compensation amount of the frequency offset in the period of receipt of the symbol in the training signal, on the basis of the estimated frequency offset amount “Δfₑₛₜ.” For example, the compensation amount determination unit 390 determines the estimated frequency offset amount “Δfₑₛₜ” as the compensation amount of the current frequency offset.

When it is determined that the period is the period of receipt of the main signal, the compensation amount determination unit 390 determines the compensation amount of the frequency offset stored (held) in the storage unit 391 in the period of receipt of the symbol in the training signal, as the compensation amount of the frequency offset in the period of receipt of the main signal.

The storage unit 391 stores the compensation amount of the frequency offset in the period of receipt of the symbol in the current training signal until it is determined that the period is the period of receipt of a symbol in the next training signal. That is, the storage unit 391 holds the compensation amount of the frequency offset in the training signal received most recently.

The frequency offset compensation unit 383 executes frequency offset compensation on the received signal (digital signal) input from the adaptive equalization filter 381, on the basis of the compensation amount determined by the compensation amount determination unit 390.

That is, when it is determined that the period is the period of receipt of a symbol in the training signal, the frequency offset compensation unit 383 executes frequency offset compensation on the received signal input from the adaptive equalization filter 381, on the basis of the compensation amount determined based on the estimated frequency offset amount “Δfₑₛₜ.” When it is determined that the period is the period of receipt of the main signal, the frequency offset compensation unit 383 executes frequency offset compensation on the received signal input from the adaptive equalization filter 381, on the basis of the held compensation amount.

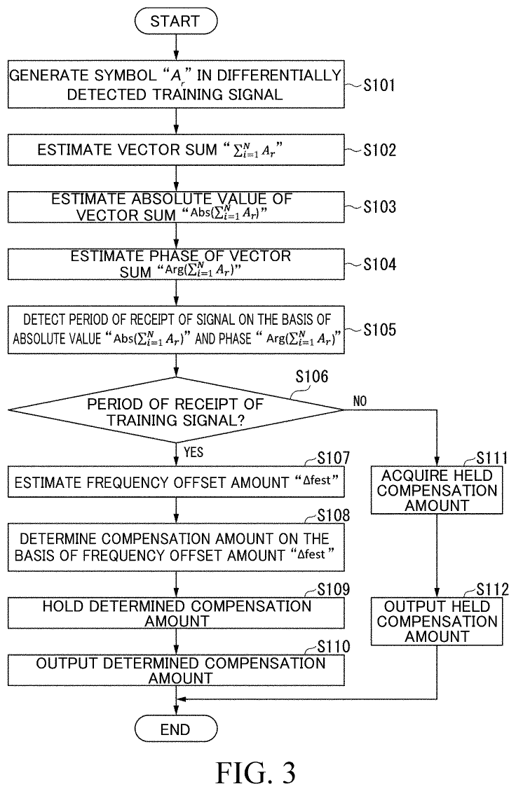

FIG. 3 is a flowchart showing an operation example of the estimation compensation unit 38 according to the first embodiment. The differential detection unit 384 generates a symbol “Aᵣ” in a differentially detected training signal (step S101). The vector sum estimation unit 385 estimates the vector sum “Σ^{N}ᵢ₌₁Aᵣ” of symbols in the differentially detected training signal (step S102).

The absolute value estimation unit 386 estimates an absolute value “Abs(Σ^{N}ᵢ₌₁Aᵣ)” of the vector sum of symbols in the differentially detected training signal (step S103). The phase estimation unit 387 estimates the phase “Arg(Σ^{N}ᵢ₌₁Aᵣ)” of the vector sum of symbols in the differentially detected training signal (step S104).

The detection unit 388 detects the period of receipt of the training signal on the basis of at least either one of the absolute value of the vector sum “Abs(Σ^{N}ᵢ₌₁Aᵣ)” and the phase of the vector sum “Arg(Σ^{N}ᵢ₌₁Aᵣ).” The detection unit 388 may detect the period of receipt of the main signal on the basis of at least either one of the absolute value of the vector sum “Abs(Σ^{N}ᵢ₌₁Aᵣ)” and the phase of the vector sum “Arg(Σ^{N}ᵢ₌₁Aᵣ)” (step S105).

The detection unit 388 determines whether or not the period is the period of receipt of a symbol in the training signal (period of receipt of the training signal) (step S106). When it is determined that the period is the period of receipt of a symbol in the training signal (step S106: YES), the offset amount estimation unit 389 estimates the frequency offset amount “Δfₑₛₜ” on the basis of the phase “Arg(Σ^{N}ᵢ₌₁Aᵣ)” of the vector sum of symbols in the differentially detected training signal (step S107).

The compensation amount determination unit 390 determines the frequency offset compensation amount on the basis of the estimated frequency offset amount “Δfₑₛₜ” (step S108). The storage unit 391 holds the frequency offset compensation amount in the period of receipt of a symbol in the current training signal (step S109). The compensation amount determination unit 390 outputs the determined frequency offset compensation amount to the frequency offset compensation unit 383 (step S110).

When it is determined that the period is the period of receipt of a symbol in the main signal (step S106: YES), the offset amount estimation unit 389 acquires the held frequency offset compensation amount from the storage unit 391 (step S111). The compensation amount determination unit 390 outputs the held frequency offset compensation amount to the frequency offset compensation unit 383 (step S112).

In this manner described above, the vector sum estimation unit 385 estimates the vector sum of symbols in the differentially detected training signal. The detection unit 388 detects the period of receipt of at least the training signal on the basis of at least either one of the comparison result of comparing between the absolute value of the vector sum of symbols in the differentially detected training signal and the absolute value threshold, and the comparison result of comparing between the variation of the phase of the vector sum of symbols in the differentially detected training signal and the predetermined width. The compensation amount determination unit 390 may determine the compensation amount held in the storage unit 391 during the period of receipt of the differentially detected training signal, as the compensation amount in the period of receipt of the differentially detected main signal.

In this manner, the period of reception (receiving timing) of the training signal is detected based on at least either one of an absolute value and the phase of the vector sum of the training symbols and the threshold, instead of the relative value. Also, the period of receipt of the main signal is detected on the basis of a period other than the period of receipt of the training signal.

This makes it possible to detect the period of receipt of the training signal without increasing the scale of the functional unit for compensating for the frequency offset. Further, the cost of the circuit scale of the optical reception device 30 can be reduced.

### Second Embodiment

The major difference between the second embodiment and the first embodiment is that in the second embodiment, the absolute value threshold is set to be greater than the maximum value (expected value) of the absolute value of the vector sum of symbols in the differentially detected main signal. The second embodiment describes mainly the primary difference with the first embodiment.

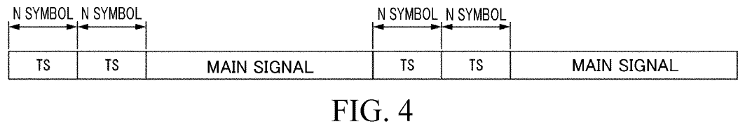

FIG. 4 is a diagram showing an example of a signal sequence according to the second embodiment. The transmission signal generation unit 13 generates a training signal (training symbol “TS”) by differential encoding in such a manner that the phase and absolute value of the vector sum of differentially detected symbols become arbitrary values. Thus, the estimation compensation unit 38 can estimate the frequency offset amount of the received signal without depending on the modulation method.

Symbols that are differentially encoded such that a phase “e” on a complex plane becomes “n” account for 50% of the whole symbols. Symbols that are differentially encoded such that the phase “e” becomes “½π” on the complex plane account for 25% of the whole symbols. Symbols that are differentially encoded such that the phase “0” becomes “ 3/2π” on the complex plane account for 25% of the whole symbols.

In FIG. 4, the average number “N” (length of training symbol) is, for example, 1024 symbols. As an example, by arranging two training signals (training symbol “TS” sequence) immediately before the main signal sequence, the two training signals are arranged in the signal sequence at regular intervals for each main signal sequence.

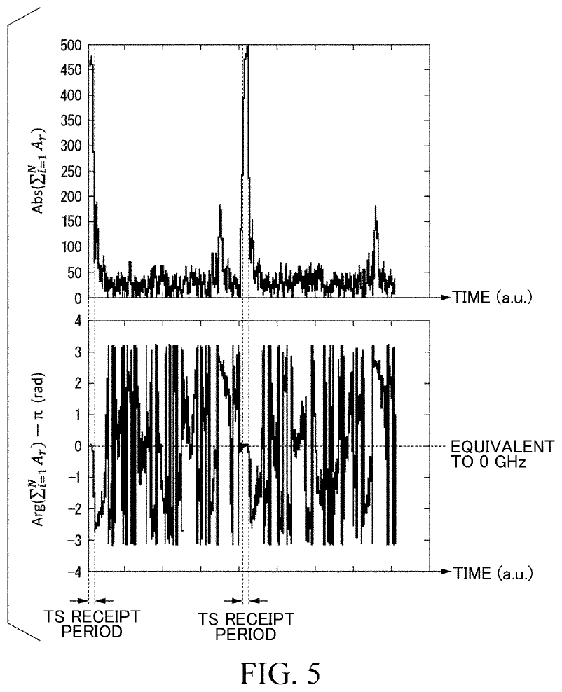

FIG. 5 is a diagram showing examples of an absolute value and a phase of a vector sum of a differentially detected QPSK signal sequence according to the second embodiment. In order to facilitate the discrimination of the phase of the vector sum, the frequency offset amount is, for example, 0 GHZ. The main signal is, for example, a signal of a 15-stage pseudo-random binary sequence (PRBS).

During the receiving period of the training signal (training symbol), the absolute value of the vector sum of the differentially detected symbols is the maximum value. In addition, during the period of receipt of the training signal, the phase “Arg(Σ^{N}ᵢ₌₁Aᵣ)” corresponding to the frequency offset amount (0 GHZ) is 0 degrees.

The absolute value of the vector sum (main signal maximum value) in the period of receipt of the main signal is sufficiently smaller than the absolute value of the vector sum in the period of receipt of the training symbol. Also, the phase of the vector sum in the period of receipt of the main signal varies randomly. This is because, in FIG. 5, since the main signal is composed of a random signal sequence, the phase of the vector sum of the differentially detected symbols is not constant.

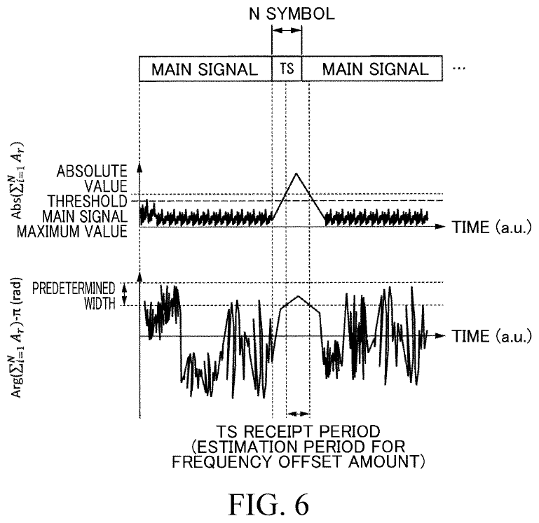

FIG. 6 is a diagram showing an example of detection of the period of receipt of the training signal according to the second embodiment. In FIG. 6, as an example, by arranging one training signals (training symbol “TS” sequence) immediately before the main signal sequence, the one training signal is arranged in the signal sequence at regular intervals for each main signal sequence.

In FIG. 6, the “main signal maximum value” is the maximum value of the vector sum of symbols in the main signal sequence. The “absolute value threshold” in FIG. 6 is a threshold for the absolute value of the vector sum of symbols in the training signal. The “predetermined width” in FIG. 6 is a predetermined width (variation width threshold) with respect to the phase of the vector sum of symbols in the training signal.

The absolute value threshold is previously determined with respect to the absolute value “Abs(Σ^{N}ᵢ₌₁Aᵣ)” of the vector sum of symbols in the differentially detected training signal.

For example, the maximum of the absolute value threshold is previously determined as the maximum of the absolute value of the vector sum of symbols in the differentially detected training signal. That is, the absolute value threshold is previously determined so as to be equal to or less than the maximum of the absolute value of the vector sum of symbols in the differentially detected training signal.

For example, the minimum value of the absolute value threshold is previously determined to a value sufficiently greater than the main signal maximum value. That is, the absolute value threshold is previously determined so as to always exceed the maximum of the absolute value of the vector sum of symbols in the differentially detected main signal.

Here, the vector sum of symbols in the main signal is estimated based on the average number “N.” The minimum value of the absolute value threshold is determined in accordance with the deviation of the symbol (e.g., the number of times the same sign continues). Therefore, the average number “N” is set to a sufficiently large value even if the maximum number of times the same sign continues in the main signal.

When the absolute value of the vector sum becomes equal to or greater than the absolute value threshold of 41, the detection unit 388 determines that the period is a period of receipt a symbol in the training signal. When the absolute value of the vector sum is less than the absolute value threshold of 41, the detection unit 388 determines that it is a period of receipt of the main signal.

Also, due to the characteristics of the detection process using the threshold, the detection timing of the training signal may have an error with respect to the period of receipt of the training signal depending on the threshold. Therefore, the offset amount estimation unit 389 may estimate the frequency offset amount after a predetermined time period from the time when the training signal is detected by the detection unit 388 using the threshold.

As described above, the absolute value of the vector sum of symbols in the differentially detected training signal is greater than the maximum value of the absolute value of the vector sum of symbols in the differentially detected main signal (the main signal maximum value).

This makes it possible to detect the period of receipt of the training signal without increasing the scale of the functional unit for compensating for the frequency offset.

### Modification of Second Embodiment

In a modification of the second embodiment, the principal difference from the second embodiment is that it is determined whether or not the state in which the absolute value of the vector sum is equal to or greater than the absolute value threshold continues for a predetermined time period (a fixed time period) or longer. The modification of the second embodiment will be described focusing on differences from the second embodiment.

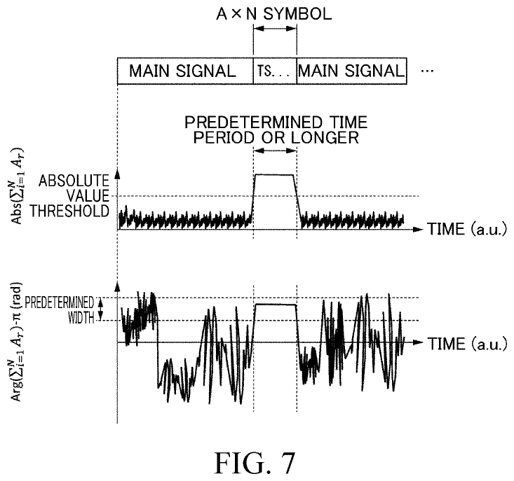

FIG. 7 is a diagram showing an example of detection of a period of receipt of a training signal according to the modification of the second embodiment. The “absolute value threshold” in FIG. 7 is a threshold for the absolute value of the vector sum of symbols in the training signal. The “predetermined width” in FIG. 7 is a variation width (variation width threshold) that is previously determined with respect to the variation of the phase of the vector sum of symbols in the training signal. In FIG. 7, a plurality (“A”) of training signals are arranged immediately before the main signal.

As shown on the upper side in FIG. 7, during the period of receipt of the training signal, the absolute value of the vector sum of symbols in the differentially detected training signal is constant for a predetermined time period or longer. Also, as shown on the lower side in FIG. 7, during the period of receipt of the training signal, the phase of the vector sum of symbols in the differentially detected training signal is constant for a predetermined time period “A×NT” or longer.

Accordingly, the detection unit 388 determines whether or not the state in which the absolute value of the vector sum is equal to or greater than the absolute value threshold continues for the predetermined time or longer. The detection unit 388 determines that the period is a period of receipt of the training signal when a state in which the absolute value of the vector sum is equal to or greater than the absolute value threshold continues for the predetermined time or longer.

Also, the detection unit 388 determines whether or not a state in which the variation of the phase of the vector sum falls within a predetermined width continues for a predetermined time or longer. The detection unit 388 determines that the period is a period of receipt of the training signal when the state in which the variation of the phase of the vector sum falls within the predetermined width continues for the predetermined time or longer.

As described above, the detection unit 388 may determine that the period is a period of receipt of the differentially detected training signal when the state in which the absolute value of the vector sum of symbols in the differentially detected training signal is equal to or greater than the absolute value threshold continues for a predetermined time or longer. Further, the detection unit 388 may determine that the period is a period of receipt of the differentially detected training signal when the state in which the variation of the phase of the vector sum of symbols in the differentially detected training signal is within the predetermined width continues for a predetermined time or longer.

This makes it possible to detect the period of receipt of the training signal without increasing the scale of the functional unit for compensating for the frequency offset.

### (Hardware Configuration)

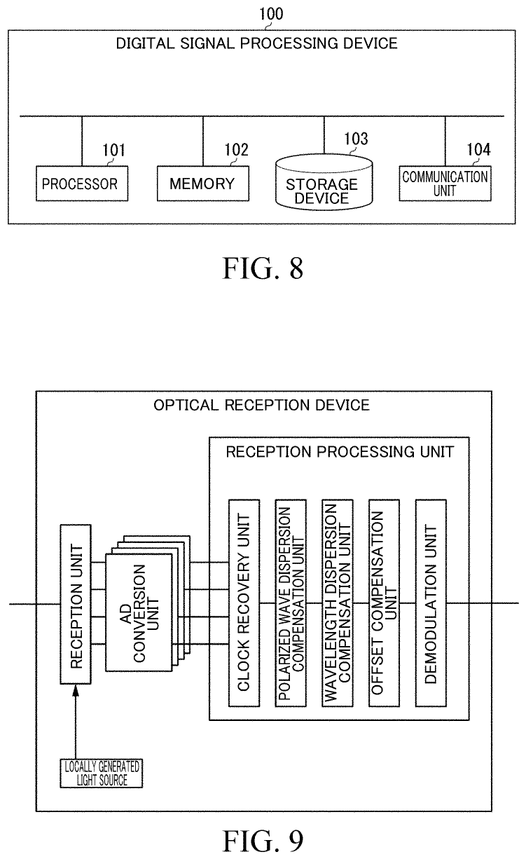

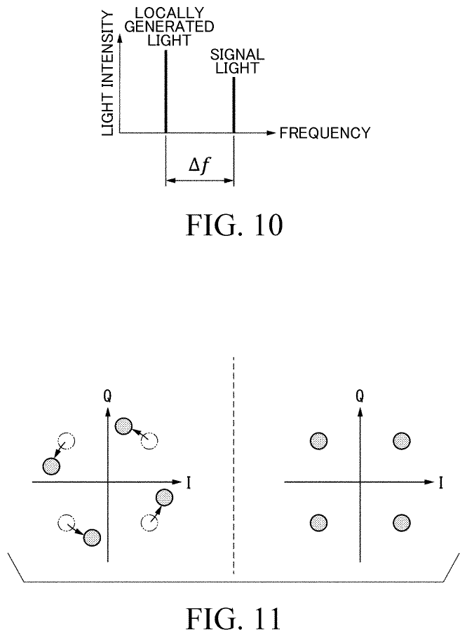

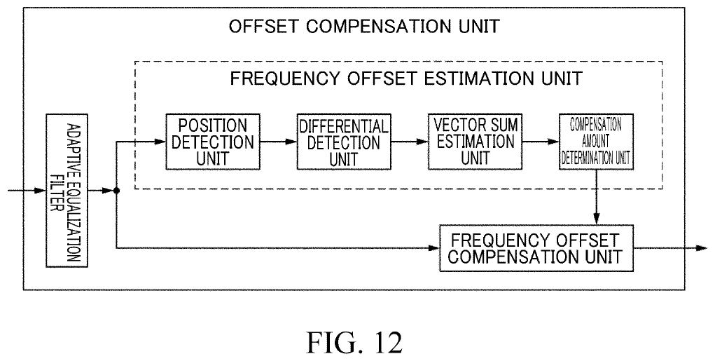

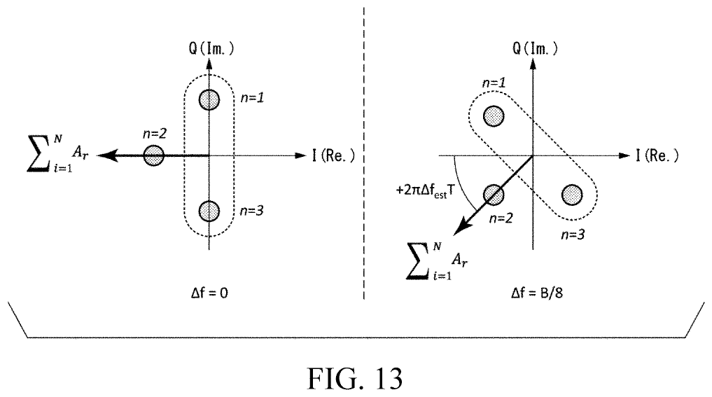

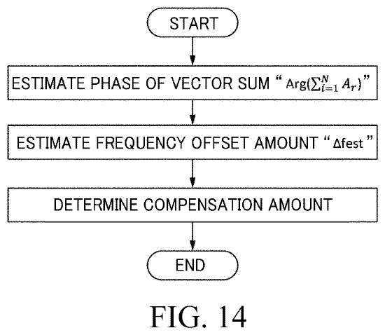

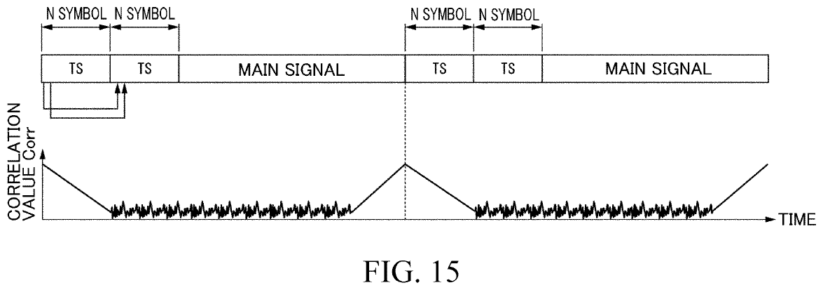

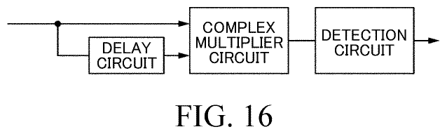

FIG. 8 is a diagram showing an example of a hardware configuration of a digital signal processing device 100 according to each embodiment. The digital signal processing device 100 corresponds to each of the hardware configuration examples of the transmission processing unit 11 and the reception processing unit 34 in each embodiment.

The digital signal processing device 100 is realized as software by causing a processor 101 such as a central processing unit (CPU) to execute a program stored in a storage device 103 having a non-volatile recording medium (non-transient recording medium) and a memory 102. The program may be recorded on a computer-readable recording medium. Examples of the computer-readable recording medium include portable media such as a flexible disc, a magneto-optical disc, a read only memory (ROM), and a compact disc read only memory (CD-ROM), and non-transitory recording media such as storage devices including a hard disk or solid state drive (SSD) built in a computer system. The communication unit 104 performs predetermined communication processing.

The digital signal processing device 100 may be realized using, for example, hardware (accelerator) including an electronic circuit (or circuitry) using a large scale integrated (LSI) circuit, an application specific integrated circuit (ASIC), a programmable logic device (PLD), a field programmable gate array (FPGA), or the like.

Although the embodiments of the present invention have been described above in detail with reference to the drawings, a specific configuration is not limited to these embodiments, and design within the scope of the gist of the present invention, and the like are included.

### INDUSTRIAL APPLICABILITY

The present invention is applicable to optical transmission systems.

### REFERENCE SIGNS LIST

1 Optical transmission system
10 Optical transmission device
11 Transmission processing unit
12 Encoding unit
13 Transmission signal generation unit
14 Waveform shaping unit
15 Pre-equalization unit
16 DA conversion unit
17 Locally generated light source
18 Transmission unit
20 Optical transmission line
30 Optical reception device
31 Locally generated light source
32 Reception unit
33 AD conversion unit
34 Reception processing unit
35 Clock recovery unit
36 Polarized wave dispersion compensation unit
37 Wavelength dispersion compensation unit
38 Estimation compensation unit
39 Demodulation unit
100 Digital signal processing device
101 Processor
102 Memory
103 Storage device
104 Communication unit
381 Adaptive equalization filter
382 Frequency offset estimation unit
383 Frequency offset compensation unit
384 Differential detection unit
385 Vector sum estimation unit
386 Absolute value estimation unit
387 Phase estimation unit
388 Detection unit
389 Offset amount estimation unit
390 Compensation amount determination unit
391 Storage unit

1. An optical reception device, comprising:
a vector sum estimator that estimates a vector sum of symbols in a differentially detected training signal; and
a detector that detects a period of receipt of at least the training signal on the basis of at least either a comparison result of comparison between an absolute value of the vector sum of symbols in the differentially detected training signal and an absolute value threshold, or a comparison result of comparison between a variation of a phase of the vector sum of symbols in the differentially detected training signal and a predetermined width.

2. The optical reception device according to claim 1, further comprising:
an offset amount estimator that estimates a frequency offset amount on the basis of the phase of the vector sum of symbols in the differentially detected training signal when the period of receipt of the differentially detected training signal is detected; and
a compensation amount determiner that determines a compensation amount of a frequency offset on the basis of the frequency offset amount and records the compensation amount in a storage, wherein
the compensation amount determiner determines the compensation amount held in the storage during the period of receipt of the differentially detected training signal as the compensation amount obtained during the period of receipt of the differentially detected main signal.

3. The optical reception device according to claim 1, wherein the absolute value of the vector sum of symbols in the differentially detected training signal is greater than a maximum value of an absolute value of a vector sum of symbols in a differentially detected main signal.

4. The optical reception device according to claim 1, wherein the detector determines that, when a state in which the absolute value of the vector sum of symbols in the differentially detected training signal is equal to or greater than the absolute value threshold continues for a predetermined time period or longer, a period is the period of receipt of the differentially detected training signal.

5. The optical reception device according to claim 1, wherein the detector determines that, when a state in which the variation of the phase of the vector sum of symbols in the differentially detected training signal is within the predetermined width continues for a predetermined time period or longer, a period is the period of receipt of the differentially detected training signal.

6. A signal detection method to be executed by an optical reception device, the signal detection method comprising:
estimating a vector sum of symbols in a differentially detected training signal; and
detecting a period of receipt of at least the training signal on the basis of at least either a comparison result of comparison between an absolute value of the vector sum of symbols in the differentially detected training signal and an absolute value threshold, or a comparison result of comparison between a variation of a phase of the vector sum of symbols in the differentially detected training signal and a predetermined width.
